(19) United States
(12) Patent Application Publication
(10) Pub. No.: US 2023/0283816 A1
(43) Pub. Date: Sep. 7, 2023

(54) VIDEO DISTRIBUTION SYSTEM, VIDEO DISTRIBUTION METHOD, TRANSMISSION DEVICE, AND TRANSMISSION PROGRAM

(71) Applicant: NIPPON TELEGRAPH AND TELEPHONE CORPORATION, Tokyo (JP)

(72) Inventors: Toshihito FUJIWARA, Musashino-shi, Tokyo (JP); Tomohiro TANIGUCHI, Musashino-shi, Tokyo (JP); Hiroya ONO, Musashino-shi, Tokyo (JP)

(73) Assignee: NIPPON TELEGRAPH AND TELEPHONE CORPORATION, Tokyo (JP)

(21) Appl. No.: 18/011,462

(22) PCT Filed: Jun. 26, 2020
(86) PCT No.: PCT/JP2020/025310

§ 371 Date: Dec. 19, 2022

(51) Int. Cl. H04N 21/236; H04N 21/4385

(52) U.S. Cl. CPC H04N 21/23614; H04N 21/4385

(57) ABSTRACT

The present disclosure has an object to make it possible to transfer a large volume of image data to display devices that are at remote locations and that have different display performances, through a plurality of networks having different available bandwidths.

In an image delivery system in the present disclosure, a sending device packetizes image data by at least one of a frame and a scanning line, writes a plurality of identifiers in headers, and sends packets, and a receiving device selectively receives image data for which a predetermined identifier of the plurality of identifiers is written in the header.

### TECHNICAL FIELD

The present invention relates to a system that delivers a screen to a remote location through a network.

### BACKGROUND ART

Conventionally, image data has been transferred to a display device such as a display and a monitor by using a connection scheme on the premise of connection in a short distance of about several meters to several tens of meters. For example, HDMI (High-Definition Multimedia Interface) (R) [Non-Patent Literature 1] is a scheme that is widely used for connecting a computer and a monitor or connecting a television and relevant AV (Audio/Visual) equipment, and cannot directly connect equipment at a remote location several kilometers away, to transfer image data.

A device for converting a signal for the HDMI into a signal appropriate for communication is used for transferring image data to a remote location. A scheme of performing the IP (Internet Protocol) packetization of the HDMI signal in a predetermined form, and the like are known [Non-Patent Literatures 2 and 3].

### CITATION LIST

### Non-Patent Literature

Non-Patent Literature 1: https://www.hdmi.org/spec/hdmi2_1
Non-Patent Literature 2: https://www.aja-jp.com/news/press/1068-aja-announces-ipt-10g2-hdmi-and-ipt-10g2-sdi
Non-Patent Literature 3: http://h-path.co.jp/service_product/3-monitoring-with-transmitter-receiver/

### SUMMARY OF THE INVENTION

### Technical Problem

For transferring the image data to the remote location, there is a case where one image source is concurrently delivered not only to one display device but also to a plurality of display devices. Particularly, for achieving a low-delay delivery, it is necessary to transfer uncompressed image data.

In conventional schemes of transferring the uncompressed image data through a network, as exemplified by HDMI, it is not possible to achieve an efficient delivery of one image source to a plurality of display devices. For example, by multicast, an identical image data is merely delivered to all display devices. Such a system has two problems.

One problem is that there may in some cases be no network bandwidth for transmitting sufficient uncompressed image data to all receiving devices. When the delivery is uniformly executed at a high image quality and a high frame rate, uncompressed image data leads to a large amount of data. Therefore, image contents cannot be displayed in a network with an insufficient bandwidth. In addition, the network bandwidth is suppressed, and other communications are also disturbed. Further, when the delivery is performed so as to be suitable for a low network bandwidth, there is a problem in that it is not possible to perform the delivery while keeping the quality of the image source with a high image quality and a high frame rate.

The other problem is that there may in some cases be no display device that can display an image corresponding to the pixel and frame rate of the image source. In the case where the image source is dynamically changed each time instead of a static system or in the case where the delivery is performed to many display devices, it is difficult to cause all display devices to support all image source formats.

Accordingly, an object of the present disclosure is to make it possible to transfer a large volume of image data to display devices that are at remote locations and that have different display performances, through a plurality of networks having different available bandwidths.

### Means for Solving the Problem

The sending side sends image data as packets having different identifiers for a frame or scanning line, and the receiving side selectively receives packets having a predetermined identifier depending on the network bandwidth or displayable image quality.

Specifically, in an image delivery system in the present disclosure,
a sending device packetizes image data by at least one of a frame and a scanning line, writes a plurality of identifiers in headers, and sends packets, and
a receiving device selectively receives image data for which a predetermined identifier of the plurality of identifiers is written in the header.

Specifically, in an image delivery method in the present disclosure,
a sending device packetizes image data by at least one of a frame and a scanning line, writes a plurality of identifiers in headers, and sends packets, and
a receiving device selectively receives image data for which a predetermined identifier of the plurality of identifiers is written in the header.

Specifically, a sending device in the present disclosure includes:
a signal analysis unit that identifies at least one of a frame and a scanning line of image data;
a packetization unit that packetizes the image data by at least one of the frame and the scanning line; and
a data transmission unit that writes a plurality of identifiers in headers and transmits packets generated by the packetization unit.

A sending program in the present disclosure is a program that realizes a computer as each functional unit included in the sending device according to the present disclosure, and is a program that causes the computer to execute each step included in a sending method to be executed by the sending device according the present disclosure.

### Effects of the Invention

According to the present disclosure, it is possible to transfer a large volume of image data to display devices that are at remote locations and that have different display performances, through a plurality of networks having different available bandwidths.

### BRIEF DESCRIPTION OF DRAWINGS

FIG. 1 shows an example of a schematic configuration of the present disclosure.

FIG. 2 shows an exemplary control of an address using a frame.

FIG. 3 shows an exemplary control of the address using a scanning line.

FIG. 4 shows an exemplary control of the address using data other than picture data.

FIG. 5 shows a first exemplary arrangement of audio data.

FIG. 6 shows a second exemplary arrangement of the audio data.

FIG. 7 shows an exemplary system configuration of the present disclosure.

### DESCRIPTION OF EMBODIMENTS

Embodiments of the present disclosure will be described below in detail with reference to the drawings. The present disclosure is not limited to the embodiments shown below. The embodiments are examples only, and the present disclosure can be carried out in any form in which various modifications and improvements are made based on the knowledge of those in the art. In the specification and drawings, identical reference characters denote identical constituent elements.

(Specific Description of Developmental Technology)

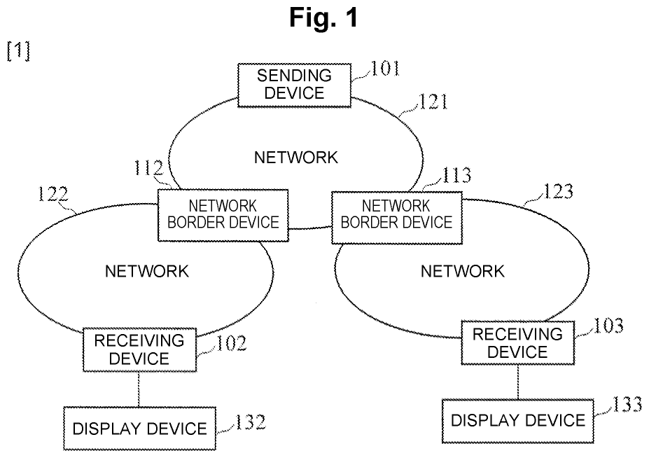

A schematic configuration of an image delivery system in the present disclosure will be described with reference to FIG. 1. The sending side transmits one image source with different identifiers being used for delivery depending on the kind of data such as the numbers of pixels and frames, or the order of frames, and the receiving side receives packets while selecting the identifier and thereby can obtain image data with the necessary numbers of pixels and frames. Thereby, by the transmission of only one image source from the sending side, it is possible to selectively receive and display the image data depending on a network bandwidth on the receiving side or the image quality that can be displayed by a display device. Particularly, even in the case where there are a plurality of or a large number of receiving devices or display devices on the receiving side or in the case where a plurality of networks intervene between the sending side and the receiving side, a plurality of image sources are not necessary in the present invention, and therefore the system is easily extended.

The identifier to be used for the delivery is an arbitrary identifier written in the header of the packet that can be read by general network equipment such as a router and a switch, and for example, is exemplified as follows.
(1) Ethernet (R): destination MAC (Media Access Control address) address, source MAC address
(2) IP (Internet Protocol): destination address, source address, ToS
(3) TCP/UDP (Transmission Control Protocol/User Datagram Protocol): source port number, destination port number
(4) VLAN (Virtual Local Area Network) (802.1Q, 802.lad): VLAN ID, priority (PCP)
(5) VXLAN (Virtual eXtensible Local Area Network): VXLAN ID (VNI), Outer identifier complying with (1-4)
(6) NVGRE (Network Virtualization using Generic Routing Encapsulation): Tenant Network Identifier (TNI), Outer identifier complying with (1-4)
(7) STT (Spin Torque Transfer): Context ID
(8) MPLS (Multi-Protocol Label Switching): label, EXP (Experimental) bit
(9) PPPoE (Point-to-Point Protocol over Ethernet): session ID
(10) L2TP (Layer 2 Tunneling Protocol): tunnel ID, session ID

In the case where an address is used as the identifier, the address may be any or both of a source address and a destination address. Further, as the destination address, a multicast address can be used. Further, other than the address, a different identifier included in the header of the packet or the like may be used. For example, in the case of a TCP/IP packet, a port number can be used. In this way, an arbitrary identifier corresponding to a protocol used for the packet can be employed.

Furthermore, a case where an IP address is used as the identifier will be described. For example, in the data of one screen, 239.0.0.1 that is a multicast address is used as the destination address for packets containing data of pixels on an even-number-th running line, 239.0.0.2 that is a multicast address is used as the destination address for packets containing data of pixels on an odd-number-th running line, and the receiving side can select the receiving of only 239.0.0.1, the receiving of only 239.0.0.2, and the receiving of both 239.0.0.1 and 239.0.0.2. Further, in the case of the multicast address, by separately transferring packets from the receiving side only to a route on which the network side is a receiving terminal by MLD (Multicast Listener Discovery) or IGMP (Internet Group Management Protocol), it is possible to restrain a useless packet transmission to a route with no receiving terminal.

That is, by the method, without using a device that deeply understands the interior of data, as exemplified by a DPI (Deep Packet Inspection) device, it is possible to achieve a selective delivery of contents with general network equipment that can read the header information in the packet, as exemplified by a router and a switch. Hereinafter, in the present disclosure, the case where the identifier is an address will be described.

Suppose that the delivery is performed from a sending device 101 to a receiving device 102 through a network 121, a network border device 112 and a network 122 and concurrently the delivery is performed to a receiving device 103 through the network 121, a network border device 113 and a network 123. The sending device 101 delivers one image source using different addresses A and B depending on the pixel and frame.

In the case where the network 122 and the receiving device 102 can perform receiving at a high image quality and a high frame rate, the network 122 and the receiving device 102 can reproduce contents using the one original image source, by receiving both the address A and the address B. On the other hand, in the case where the network 123 and the receiving device 103 can perform transfer and receiving only at a low image quality and a low frame rate, the receiving device 103 receives the data with only one address.

When the address is a multicast address, only the data with the address selected by the receiving device 103 is transferred from the network border device 113 to the network 123, and therefore, load is avoided from being needlessly put on the network 123 and the receiving device 103.

In the case where the display device 132 has a display performance of a high image quality and a high frame rate, the receiving device 102 can reproduce contents using the one original image source, by receiving both the address A and the address B. On the other hand, in the case where the display device 133 has a display performance of a low image quality and a low frame rate, the receiving device 103 receives the data with only one address of the addresses A and B.

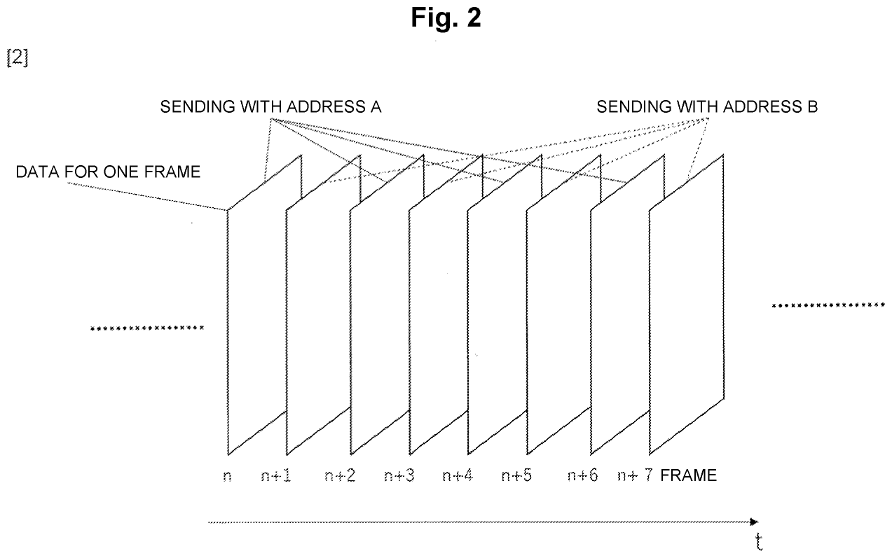

A case where an address control is performed using the frame will be described with reference to FIG. 2. The sending side transmits a 2k-th frame with the address A, and transmits a 2k+1-th frame with the address B. That is, the transmission is performed while the address {A, B} is repeated for each frame.

A receiving side that can perform the receiving at a high frame rate receives the address A and the address B. A receiving side that can perform only the receiving at a low frame rate selectively receives only the address A or the address B. For example, in the case where the image data to be sent has 60 fps, when the addresses A and B are received, data having 60 fps can be received and when only the address A or B is received, the data amount is reduced by half, so that data having 30 fps can be received.

The case where the data amount and the frame rate are reduced to ½ has been described above, but the present disclosure is not limited to this.

For example, in the case of {A, B, A, C}, data with the original frame rate can be received when all of the addresses A, B and C are received, data with ½ of the data amount and frame rate can be received when only the address A or the addresses B and C are received, and data with ¼ of the data amount and frame rate can be received when only the address B or C is received.

For example, in the case of {A, B, C}, data with the original frame rate can be received when all of the addresses A, B and C are received, data with ⅔ of the data amount and frame rate can be received when the addresses A and B, the addresses B and C or the addresses A and C are received, and data with ⅓ of the data amount and frame rate can be received when only the address A, B or C is received.

As for the image data that is used in the present disclosure, image data in which one image at a certain time includes all information is assumed, and an uncompressed image or an image having a relatively low compression ratio, as exemplified by motion JPEG (Joint Photographic Experts Group) in which a technique of compression between frames is not used, is intended. Further, as for the selective use of identifiers in one screen, a progressive uncompressed image is assumed.

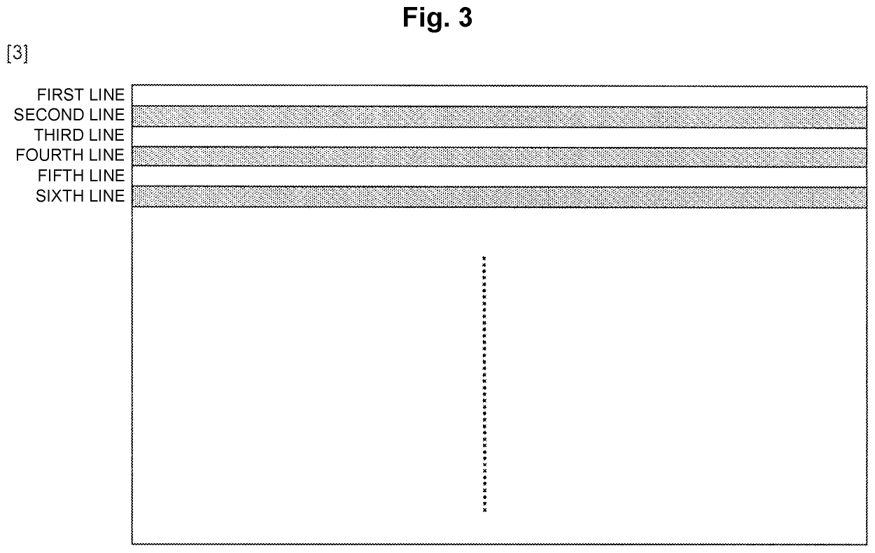

A case where an address control is performed using a scanning line will be descried with reference to FIG. 3. The sending side transmits a 2k-th scanning line with the address A, and transmits a 2k+1-th scanning line with the address B. That is, the transmission is performed while the address {A, B} is repeated for each scanning line.

A receiving side that can perform the receiving at a high image quality receives the address A and the address B. A receiving side that can perform only the receiving at a low image quality selectively receives only the address A or the address B. For example, in the case where the line number of scanning lines in the sending image is 2160, when the addresses A and B are received, 2160 scanning lines can be received, and when only the address A or B is received, the data amount is reduced by half, so that 1080 scanning lines can be received.

The case where the data amount and the line number are reduced to ½ has been described above, but the present disclosure is not limited to this.

For example, in the case of {A, B, A, C}, data with the original line number can be received when all of the addresses A, B and C are received, data with ½ of the data amount and line number can be received when only the address A or the addresses B and C are received, and data with ¼ of the data amount and line number can be received when only the address B or C is received.

For example, in the case of {A, B, C}, data with the original line number can be received when all of the addresses A, B and C are received, data with ⅔ of the data amount and line number can be received when the addresses A and B, the addresses B and C or the addresses A and C are received, and data with ⅓ of the data amount and line number can be received when only the address A, B or C is received.

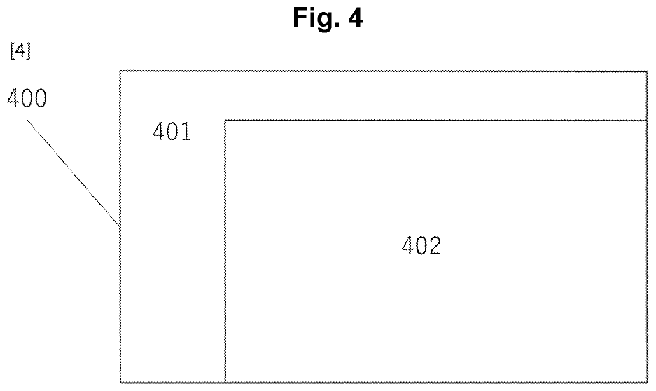

A case where the address is controlled using data other than picture (pixel) data will be described with reference to FIG. 4. Reference numeral 400 denotes the whole data series for one screen when the image data is transferred. A region 402 that is a part of the whole data series is pixel data, and is the control object described above, and a remaining region 401 is the other data such as audio data.

Pattern 1

Information such as audio can be received as the same data, regardless of the image quality and frame rate in the receiving. Therefore, for the data in the region 401, a different address from the address used for the region 402 can be used. It is possible to receive the audio and others without interruption, by commonly receiving the address only for the region 401 regardless of the image quality and frame rate in the receiving.

Pattern 1

Information such as audio can be received as the same data, regardless of the image quality and frame rate in the receiving. Therefore, the region 401 can be controlled with the same address as the region 402, and further can be moved to a data region in which the audio information and others are commonly received. For example, in the case where the image is divided by {A, B} and where there are a receiving device that receives (A, B) and a receiving device that receives only (A), the audio data and others originally included in the address B can be moved to a data region for the address A. Thereby, it is possible to receive the audio and others without interruption.

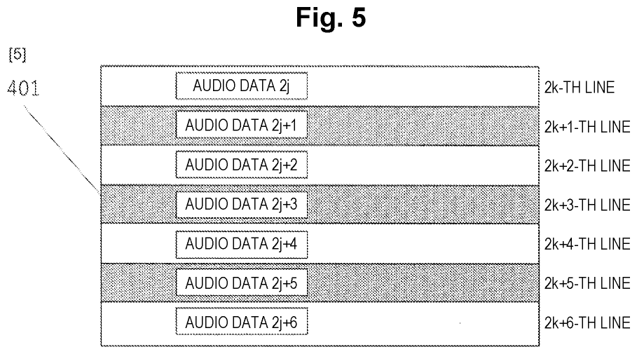

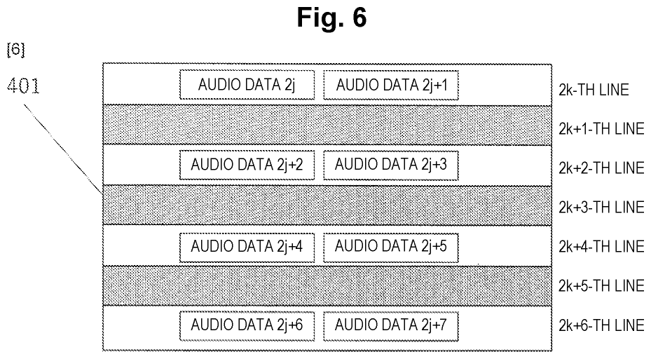

FIG. 5 shows an exemplary arrangement of audio data at a part of the region 401. In the case where the region 401 is controlled with the same address as the region 402 and where there is, for example, a terminal that receives only the data on even-number lines, the audio data is missed. Hence, as shown in FIG. 6, only the audio data is collected on the even-number lines at the time of sending, and thereby, it is possible to receive the audio data without missing the audio data, even by the receiving of only the even-number lines. The same goes for the selective receiving of the screen frame. Further, the receiving side is allowed to return the audio data to the original audio data position, and is allowed not to return the audio data to the original audio data position.

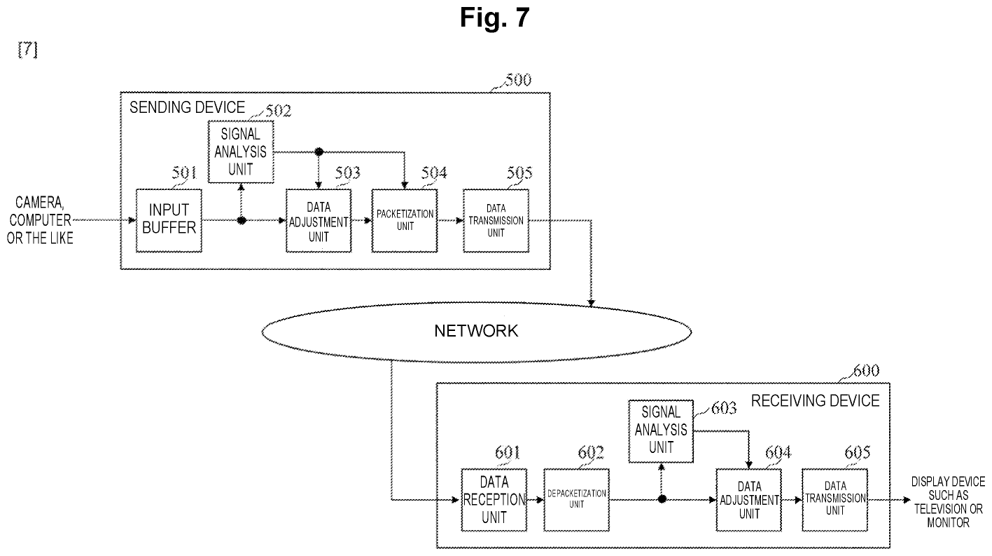

An exemplary system configuration of the present disclosure will be described with reference to FIG. 7. Reference numeral 500 denotes the sending device in the system, and reference numeral 600 denotes the receiving device. The sending device 500 transmits the image data input from a camera or a computer by an interface such as HDMI, HD-SDI, USB and GigE, to a network, and the receiving device 600 receives the image data from the sending device 500 and outputs the image data to a television or a monitor by an interface such as HDMI, HD-SDI, USB and GigE.

(Sending Device)

Reference numeral 501 denotes an input buffer, and the image data is read by a signal analysis unit 502 and a data adjustment unit 503 at necessary timings.

Reference numeral 502 denotes a signal analysis unit, and the signal analysis unit 502 reads the image data from the input buffer 501, performs the identification of the frame, the identification of the scanning line, the identification of the audio data and the identification of other control signals, and gives notice to the data adjustment unit 503 and a packetization unit 504. Data itself may be given to the data adjustment unit 503.

Reference numeral 503 denotes a data adjustment unit, and the data adjustment unit 503 reads the image data from the input buffer 501 or the signal analysis unit 502, executes the swapping and rewriting of some data such as the audio data based on the information from the signal analysis unit 502, and gives the data to the packetization unit 504. On this occasion, marker data showing the rewriting may be put in.

Reference numeral 504 denotes a packetization unit, and the packetization unit 504 reads the image data from the data adjustment unit 503, and perform packetization using the above-described address, based on the information from the signal analysis unit 502.

Reference numeral 505 denotes a data transmission unit, and the data transmission unit 505 transmits the image data at a speed appropriate for the network. An FEC function may be included.

The appropriate speed is such a speed that the transmission speed of the packet is restricted to a certain speed or lower and the transmission interval of the packet is kept at a certain interval in the rate such that the packet loss in the network or the delay by the buffer in the network device is not excessively large. For example, even when the network bandwidth is 10 Gbps, if the signal rate for the image is 1 Gbps, the transmission rate of the packet is restricted to about 1 Gbps and the packet transmission interval is kept at a constant interval of about 1 Gbps, so that the packet loss in the network and an excessive delay can be restrained.

(Receiving Device)

Reference numeral 601 denotes a data reception unit, and the data reception unit 601 receives the packet from the network. At this time, image data sent using a predetermined address is selectively received depending on the network bandwidth of the data reception unit or the image quality that can be displayed by the display device. Packet loss data may be restored by the FEC function.

Reference numeral 602 denotes a depacketization unit, and the depacketization unit 602 takes data out of the packet.

Reference numeral 603 denotes a signal analysis unit, and the signal analysis unit 603 reads data from the depacketization unit 602, and determines whether the relocation of the audio data and others has been performed. The determination may be performed based on the marker data.

Reference numeral 604 denotes a data adjustment unit, and the data adjustment unit 604 executes the swapping and rewriting of some data such as the audio data based on the information from the signal analysis unit 603, builds image data that can be reproduced by the display device, and gives the data to a data output unit 605. Further, in the case where it is necessary to decrease the resolution in the lateral direction, the decimation or integration process of the data is executed. In the case where the address is changed for each scanning line, it is possible to decimate the resolution in the portrait direction, but it is difficult to decimate the resolution in the lateral direction, and therefore the decimation in the lateral direction is executed on the receiving side.

Reference numeral 605 denotes a data output unit, and the data output unit 605 performs the buffering of the data and the conversion of an IF. In the case where a response to a signal from the display device is necessary, for example, in the case of HDMI, the response is executed by the data output unit.

In the present disclosure, the receiving device and the display device may be included in one device. For example, in FIG. 1, a reception unit and a display unit that are included in the terminal may be used as the receiving device 102 and the display device 132. Further, the sending device and receiving device in the present disclosure can be realized by a computer and a program, and the program can be recorded in a recording medium or can be provided through a network.

(Effect Produced by Invention)

It is possible to provide means for transferring one image having a large volume to a plurality of display devices that are at remote locations and that have different display performances, through a plurality of networks having different available bandwidths.

(Point of Invention)

Conventionally, for uncompressed image, an interface for connection in a short distance of about several meters to several tens of meters has been used. A system that performs a low-delay transfer by transferring this through a network has been proposed, but for the concurrent delivery to many receiving devices, only the multicast is used, and the concurrent delivery cannot be performed to display devices that have small network bandwidths or have different display performances.

In the present invention, the sending side transmits one image with different identifiers being used for delivery depending on the kind and order of data such as the pixel and the frame, and the receiving side selectively receives the packet depending on the identifier and thereby can obtain the image with the necessary numbers of pixels and frames, so that it is possible to selectively receive and display the image depending on the network bandwidth or the displayable image quality on the receiving side, by the transmission of only one image on the sending side. Particularly, in the case where there are a plurality of or a large number of networks or receiving devices on the receiving side, a plurality of image sources are not necessary in the present invention, and therefore the system is easily extended. Furthermore, an identifier in an existing network packet header is used for traffic selection on the network, and thereby it is possible to realize the system with existing network equipment.

### INDUSTRIAL APPLICABILITY

The present disclosure can be applied to the information communication industry.

### REFERENCE SIGNS LIST

101 Sending device
102, 103 Receiving device
112, 113 Network border device
121, 122, 123 Network
500 Sending device
501, 601 Input buffer
502, 603 Signal analysis unit
503, 604 Data adjustment unit
504 Packetization unit
505 Data transmission unit
600 Receiving device
602 Depacketization unit
605 Data output unit

1. An image delivery system, wherein
a sending device packetizes image data by at least one of a frame and a scanning line, writes a plurality of identifiers in headers, and sends packets, and
a receiving device selectively receives image data for which a predetermined identifier of the plurality of identifiers is written in the header.

2. The image delivery system according to claim 1, wherein
the receiving device receives image data with an identifier that is determined based on at least one of network bandwidth and image quality.

3. The image delivery system according to claim 1, wherein
the sending device sends different data from the image data with a different identifier from the identifiers in the image data being written in headers.

4. The image delivery system according to claim 1, wherein
the sending device packetizes each of first image data and second image data, and sends the first image data and the second image data with different identifiers being written in headers, the first image data being image data resulting from decimating at least of the frame and the scanning line from an image source, the second image data being image data decimated from the image source for the first image data.

5. The image delivery system according to claim 4, wherein the receiving device
receives the first image data and the second image data, and
combines the first image data and the second image data, to build image data that can be reproduced by a display device.

6. An image delivery method, wherein
a sending device packetizes image data by at least one of a frame and a scanning line, writes a plurality of identifiers in headers, and sends packets, and
a receiving device selectively receives image data for which a predetermined identifier of the plurality of identifiers is written in the header.

7. A sending device comprising:
a signal analysis unit that identifies at least one of a frame and a scanning line of image data;
a packetization unit that packetizes the image data by at least one of the frame and the scanning line; and
a data transmission unit that writes a plurality of identifiers in headers and transmits packets generated by the packetization unit.

8. A non-transitory computer-readable medium having computer-executable instructions that, upon execution of the instructions by a processor of a computer, cause the computer to function as the sending device according to claim 7.
